(19) United States
(12) Patent Application Publication
(10) Pub. No.: US 2010/0303154 A1
(43) Pub. Date: Dec. 2, 2010

(54) METHOD AND DEVICE FOR VIDEO SEQUENCE DECODING WITH ERROR CONCEALMENT

(75) Inventors: Herve Le Floch, Rennes (FR); Eric Nassor, Thorigne Fouillard (FR)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Ohta-ku, Tokyo (JP)

(21) Appl. No.: 12/675,157

(22) PCT Filed: Aug. 29, 2008
(86) PCT No.: PCT/EP08/07087

§ 371 Date: May 5, 2010

(30) Foreign Application Priority Data
Aug. 31, 2007 (FR) 07/06135

(51) Int. Cl. H04N 7/32; H04N 7/26

(52) U.S. Cl. 375/240.16; 375/240.12; 375/E07.246; 375/E07.125

(57) ABSTRACT

The invention concerns a method for decoding a video sequence encoded according to a predictive format, which video sequence includes predicted images containing encoded residual data representing differences between the respective predicted image and a respective reference image in the video sequence.

The method comprises, for a current predicted image of the video sequence, the steps of:
determining (E51) at least one first area of the current predicted image according to meeting of a predetermined criterion;
for at least part of the determined at least one first area, applying an error concealment method (E514), said error concealment method using residual data of the current predicted image relative to said part.

### BACKGROUND OF THE INVENTION

1. Field of the Invention

The invention concerns a method and device for video sequence decoding with error concealment.

The invention belongs to the domain of video processing in general and more particularly to the domain of decoding with error concealment after the loss or corruption of part of the video data, for example by transmission through an unreliable channel.

2. Description of the Prior-Art

Compressed video sequences are very sensitive to channel disturbances when they are transmitted through an unreliable environment such as a wireless channel. For example, in an IP/Ethernet network using the UDP transport protocol, there is no guarantee that the totality of data packets sent by a server is received by a client. Packet loss can occur at any position in a bitstream received by a client, even if mechanisms such as retransmission of some packets or redundant data (such as error correcting codes) are applied.

In case of unrecoverable error, it is known, in video processing, to apply error concealment methods, in order to partially recover the lost or corrupted data from the compressed data available at the decoder.

Most video compression methods, for example H.263, H.264, MPEG1, MPEG2, MPEG4, SVC, use block-based discrete cosine transform (DCT) and motion compensation to remove spatial and temporal redundancies. Each frame of the video sequence is divided into slices which are encoded and can be decoded independently. A slice is typically a rectangular portion of the image, or more generally, a portion of an image. Further, each slice is divided into macroblocks (MBs), and each macroblock is further divided into blocks, typically blocks of 8×8 pixels. The encoded frames are of two types: predicted frames (either predicted from one reference frame called P-frames or predicted from two reference frames called B-frames) and non predicted frames (called INTRA frames or I-frames).

For a predicted frame, the following steps are applied at the encoder:
motion estimation applied to each block of the considered predicted frame with respect to a reference frame, resulting in a motion vector per block pointing to a reference block of the reference frame. The set of motion vectors obtained by motion estimation form a so-called motion field.
prediction of the considered frame from the reference frame, where for each block, the difference signal between the block and its reference block pointed to by the motion vector is calculated. The difference signal is called in the subsequent description residual signal or residual data. A DCT is then applied to each block of residual signal, and then, quantization is applied to the signal obtained after the DCT;
entropic encoding of the motion vectors and of the quantized transformed residual data signal.

For an INTRA encoded frame, the image is divided into blocks of pixels, a DCT is applied on each block, followed by quantization and the quantized DCT coefficients are encoded using an entropic encoder.

In practical applications, the encoded bitstream is either stored or transmitted through a communication channel.

At the decoder side, for the classical MPEG-type formats, the decoding achieves image reconstruction by applying the inverse operations with respect to the encoding side. For all frames, entropic decoding and inverse quantization are applied.

For INTRA frames, the inverse quantization is followed by inverse block DCT, and the result is the reconstructed image signal.

For predicted type frames, both the residual data and the motion vectors need to be decoded first. The residual data and the motion vectors may be encoded in separate packets in the case of data partitioning. For the residual signal, after inverse quantization, an inverse DCT is applied. Finally, for each predicted block in the P-frame, the signal resulting from the inverse DCT is added to the reconstructed signal of the block of the reference frame pointed out by the corresponding motion vector to obtain the final reconstructed image signal.

In case of loss or corruption of data packets of the bitstream, for example when the bitstream is transmitted though an unreliable transmission channel, it is known to apply error concealment methods at the decoder, in order to use the data correctly received to reconstruct the lost data.

The error concealment methods known in the prior art can be separated into two categories:
temporal error concealment methods, and
spatial error concealment methods.

Temporal error concealment methods reconstruct a field of motion vectors from the data available, and apply the reconstructed motion vector corresponding to a lost data block in a predicted frame to allow the prediction of the luminance of the lost data block from the luminance of the corresponding block in the reference frame. For example, if the motion vector for a current block in a current predicted image has been lost or corrupted, a motion vector can be computed from the motion vectors of the blocks located in the spatial neighborhood of the current block.

The temporal error concealment methods are efficient if there is sufficient correlation between the current decoded frame and the previous frame used as a reference frame for prediction. Therefore, temporal error concealment methods are preferably applied to entities of the predicted type (P frames or P slices), when there is no change of scene resulting in motion or luminance discontinuity between the considered predicted entities and the previous frame(s) which served as reference for the prediction.

Spatial error concealment methods use the data of the same frame to reconstruct the content of the lost data block(s).

In a prior-art rapid spatial error concealment method, the available data is decoded, and then the lost area is reconstructed by luminance interpolation from the decoded data in the spatial neighborhood of the lost area. Spatial error concealment is generally applied for image frames for which the motion or luminance correlation with the previous frame is low, for example in the case of scene change. The main drawback of classical rapid spatial interpolation is that the reconstructed areas are blurred, since the interpolation can be considered equivalent to a kind of low-pass filtering of the image signal of the spatial neighborhood.

The article ‘Object removal by exemplar-based inpainting” by Criminisi et al, published in CVPR 2003 (IEEE Conference on Computer Vision and Pattern Recognition) describes a spatial error concealment method which better preserves the edges in an interpolated area by replicating available decoded data from the same frame to the lost or corrupted area, in function of a likelihood of resemblance criterion. The article describes an algorithm for removing large objects from digital images, but it can also be applied as an error concealment method. The algorithm proposed replicates both texture and structure to fill-in the blank area, using propagation of already synthesized values of the same image, to fill the blank image progressively, the order of propagation being dependent on a confidence measure. The algorithm is complex and needs high computational capacities and a relatively long computational time. Moreover, the experiments show that in some cases, the reconstructed area is completely erroneous and shows false edges, which where not present in the initial image.

Generally, in particular in the case of real-time video decoding for display, the classical error concealment methods which are applied are rapid but the quality of reconstruction is relatively poor. The reconstructed parts of an image are then used in the decoding process for the decoding of the following predicted frame, as explained above. However, if an image area is poorly rendered, it is likely that the predicted blocks using that area would also show a relatively bad quality.

### SUMMARY OF THE INVENTION

The present invention aims to alleviate the prior art drawbacks, by improving the quality of reconstruction of images of the video sequence, in particular for images that depend on previous images with a poor reconstruction quality or for images that have suffered a partial loss.

To that end, the invention concerns a method for decoding a video sequence encoded according to a predictive format, which video sequence includes predicted images containing encoded residual data representing differences between the respective predicted image and a respective reference image in the video sequence, the method comprising, for a current predicted image of the video sequence, the steps of:
determining at least one first area of the current predicted image according to meeting of a predetermined criterion;
for at least part of the determined at least one first area, applying an error concealment method, said error concealment method using residual data of the current predicted image relative to said part.

Thus the invention makes it possible to improve the reconstruction quality of a determined area or areas designated as first area(s), by applying an error concealment method instead of classical decoding of the available data, the error concealment method making use of the residual data relative to the determined area in order to improve the reconstruction quality. The residual data carries edge information, as will be shown in the description. Embodiments of the invention may therefore achieve better quality by applying an improved error concealment using edge-type information from the residual data as compared to the classical decoding process which simply adds residual data on the predicted data from the reference frame which has a poor quality.

According to a particular aspect of the invention, the method further comprises the steps of:
evaluating whether the quality of reconstruction of an image signal is sufficient or not, which image signal temporally precedes the current predicted image and is used as a reference for the prediction of the at least one first area;
in case the quality of reconstruction is evaluated as not sufficient, determining that the predetermined criterion has been met.

Thus the invention makes it possible to reconsider the decoding of areas predicted from image parts which have low reconstruction quality, allowing therefore a progressive improvement of the video quality. The error propagation from one frame to another due to the predictive structure of the video coding format is limited thanks to this particular aspect of the invention.

In a particular embodiment, the evaluation of the quality of reconstruction takes into account the type of error concealment method used for reconstruction of said image signal temporally preceding the current predicted image and used as a reference for the prediction of the at least one first area.

In this embodiment, the quality of reconstruction is always evaluated as not sufficient if the type of error concealment method is spatial error concealment.

This particular embodiment allows the systematic detection of image areas for which the quality is not sufficient, resulting in computational efficiency.

According to a particular feature, the step of determining at least one first area further comprises the steps of:
reading the location of at least one second area in a reference image of the current predicted image, each second area containing at least part of the image signal temporally preceding the current predicted image and as a reference for the prediction of the at least one first area;
applying a projection according to motion vectors of said at least one second area on the current predicted image to obtain the location of said at least one first area.

Therefore, the at least one first area to be reconstructed in the current image can be easily located using the motion field which relates the current predicted image to a previous reference image.

In a particular embodiment, the method of the invention further comprises the steps of:
evaluating the quality of reconstruction of the image signal obtained by error concealment applied to said at least part of the at least one first area;
in case the quality of reconstruction is evaluated as not sufficient, storing the location of said part of the current predicted image.

Thus the invention further ensures the limitation of the propagation of possible reconstruction errors, by evaluating the quality of reconstruction of the image signal obtained by error concealment.

According to a feature of this particular embodiment, the quality of reconstruction is evaluated as not sufficient if the energy of the residual data corresponding to said at least part of the at least one first area is lower than a predetermined threshold.

The residual data can contain edge information which can be used, according to the invention, to improve the reconstruction quality. However, if the residual data on a block of the area to be reconstructed has low energy, it can be assumed that the enhancement is insufficient on said block. Thus, thanks to this particular feature, the reconstruction quality is even further enhanced.

According to an embodiment of the invention, the error concealment method is a spatial interpolation method, a value attributed to a pixel to be reconstructed of the at least one first area of the current predicted image being calculated from decoded values of pixels within a spatial neighborhood of said pixel to be reconstructed.

The value attributed to a pixel to be reconstructed is calculated by a weighted sum of decoded values for pixels in the neighborhood and each weighting factor depends on the residual data corresponding to said at least one first area.

According to a particular embodiment, the weighting factor associated with a pixel in the neighborhood is a function of the sum of absolute values of residual data of pixels situated on a line joining said pixel to be reconstructed and said pixel in the neighbourhood.

According to a preferred feature, the weighting factor is inversely proportional to said sum.

Thus, the quality of reconstruction is improved by taking into account the residual data values in the interpolation, so as to attribute less weight to pixels that are located in an area separated from the pixel to be reconstructed by a line of high value residual data which can be assimilated to an edge. It is assumed that in general, an edge is a border between areas with different textures, so the resemblance between two pixels separated by an edge is supposed to be relatively low.

According to an embodiment of the invention, the error concealment method selects, to reconstruct said at least part of the at least one first area, at least one of a plurality of candidates and the residual data corresponding to said at least one first area is used to choose between the plurality of candidates.

Thus, the residual data representative of edge information may be used to improve the quality of reconstruction by helping to preserve the edge coherence in the reconstructed area.

According to a possible feature, the error concealment method is a spatial block matching method, the residual data corresponding to said at least one first area being used to choose between a plurality of candidate blocks.

According to an alternative feature, the error concealment method is a motion vector correction method, the residual data corresponding to said at least one first area being used to choose between a plurality of candidate motion vectors.

Thus the invention is also useful to enhance the reconstruction quality within temporal error concealment methods.

The invention also concerns a device for decoding a video sequence encoded according to a predictive format, which video sequence includes predicted images containing encoded residual data representing differences between the respective predicted image and a respective reference image in the video sequence, comprising:
means for determining at least one first area of a current predicted image according to meeting of a predetermined criterion;
means for applying an error concealment method to at least part of the determined at least one first area, said error concealment method using residual data of the current predicted image relative to said part.

The invention also relates to a carrier medium, such as an information storage means, that can be read by a computer or a microprocessor, storing instructions of a computer program for the implementation of the method for decoding a video sequence as briefly described above.

The invention also relates to a computer program which, when executed by a computer or a processor in a device for decoding a video sequence, causes the device to carry out a method as briefly described above.

The particular characteristics and advantages of the video sequence decoding device, of the storage means and of the computer program being similar to those of the video sequence decoding method, they are not repeated here.

### BRIEF DESCRIPTION OF THE DRAWINGS

Other features and advantages will appear in the following description, which is given solely by way of non-limiting example and made with reference to the accompanying drawings, in which:

FIG. 1 is a diagram of a processing device adapted to implement the present invention;

FIG. 2a is a schematic view of a predictive encoding structure;

FIG. 2b is a schematic view of block prediction and resulting residual data;

FIG. 3 illustrates schematically the propagation of low quality reconstruction in a predictive coding scheme;

FIG. 4 illustrates schematically an embodiment of the invention;

FIG. 5 is a flowchart of a video decoding algorithm embodying the invention;

FIG. 6 is a schematic representation of a prior-art spatial interpolation method;

FIG. 7 is a schematic representation of the use of residual data to improve the a spatial interpolation according to a first embodiment of the invention;

FIG. 8 is a schematic representation of the use of residual data to improve a spatial error concealment method according to a second embodiment of the invention;

FIG. 9 is a schematic representation of the use of the residual data to improve a temporal error concealment method according to an embodiment of the invention.

### DETAILED DESCRIPTION OF THE EMBODIMENTS

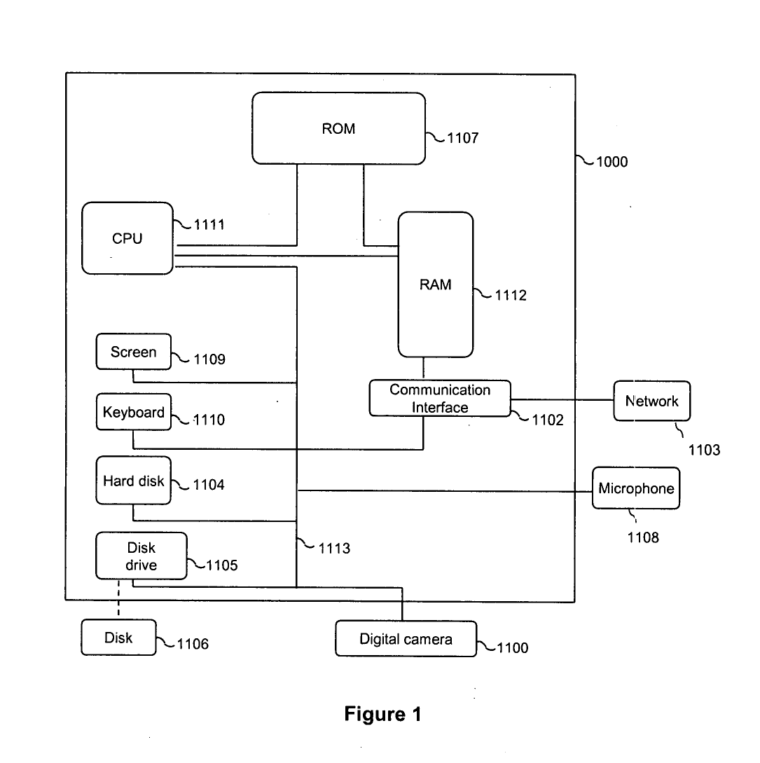

FIG. 1 is a diagram of a processing device 1000 adapted to implement the present invention. The apparatus 1000 is for example a micro-computer, a workstation or a light portable device.

The apparatus 1000 comprises a communication bus 1113 to which there is connected:
a central processing unit 1111, such as a microprocessor, denoted CPU;
a read only memory 1107 able to contain computer programs for implementing the invention, denoted ROM;
a random access memory 1112, denoted RAM, able to contain the executable code of the method of the invention as well as the registers adapted to record variables and parameters necessary for implementing the invention; and
a communication interface 1102 connected to a communication network 1103 over which digital data to be processed are transmitted.

Optionally, the apparatus 1000 may also have the following components, which are included in the embodiment shown in FIG. 1:
a data storage means 1104 such as a hard disk, able to contain the programs for implementing the invention and data used or produced during the implementation of the invention;
a disk drive 1105 for a disk 1106, the disk drive being adapted to read data from the disk 1106 or to write data onto said disk;
a screen 1109 for displaying data and/or serving as a graphical interface with the user, by means of a keyboard 1110 or any other pointing means.

The apparatus 1000 can be connected to various peripherals, such as for example a digital camera 1100 or a microphone 1108, each being connected to an input/output card (not shown) so as to supply multimedia data to the apparatus 1000.

The communication bus 1113 affords communication and interoperability between the various elements included in the apparatus 1000 or connected to it. The representation of the bus is not limiting and in particular the central processing unit is able to communicate instructions to any element of the apparatus 1000 directly or by means of another element of the apparatus 1000.

The disk 1106 can be replaced by any information medium such as for example a compact disk (CD-ROM), rewritable or not, a ZIP disk or a memory card and, in general terms, by an information storage means that can be read by a microcomputer or by a microprocessor, integrated or not into the apparatus, possibly removable and adapted to store one or more programs whose execution enables the method of decoding a video sequence according to the invention to be implemented.

The executable code enabling the apparatus to implement the invention may be stored either in read only memory 1107, on the hard disk 1104 or on a removable digital medium such as for example a disk 1106 as described previously. According to a variant, the executable code of the programs can be received by means of the communication network, via the interface 1102, in order to be stored in one of the storage means of the apparatus 1000 before being executed, such as the hard disk 1104.

The central processing unit 1111 is adapted to control and direct the execution of the instructions or portions of software code of the program or programs according to the invention, instructions that are stored in one of the aforementioned storage means. On powering up, the program or programs that are stored in a non-volatile memory, for example on the hard disk 1104 or in the read only memory 1107, are transferred into the random access memory 1112, which then contains the executable code of the program or programs according to the invention, as well as registers for storing the variables and parameters necessary for implementing the invention.

It should be noted that the apparatus can also be a programmed apparatus. This apparatus then contains the code of the computer program or programs, for example fixed in an application specific integrated circuit (Application Specific Integrated Circuit or ASIC).

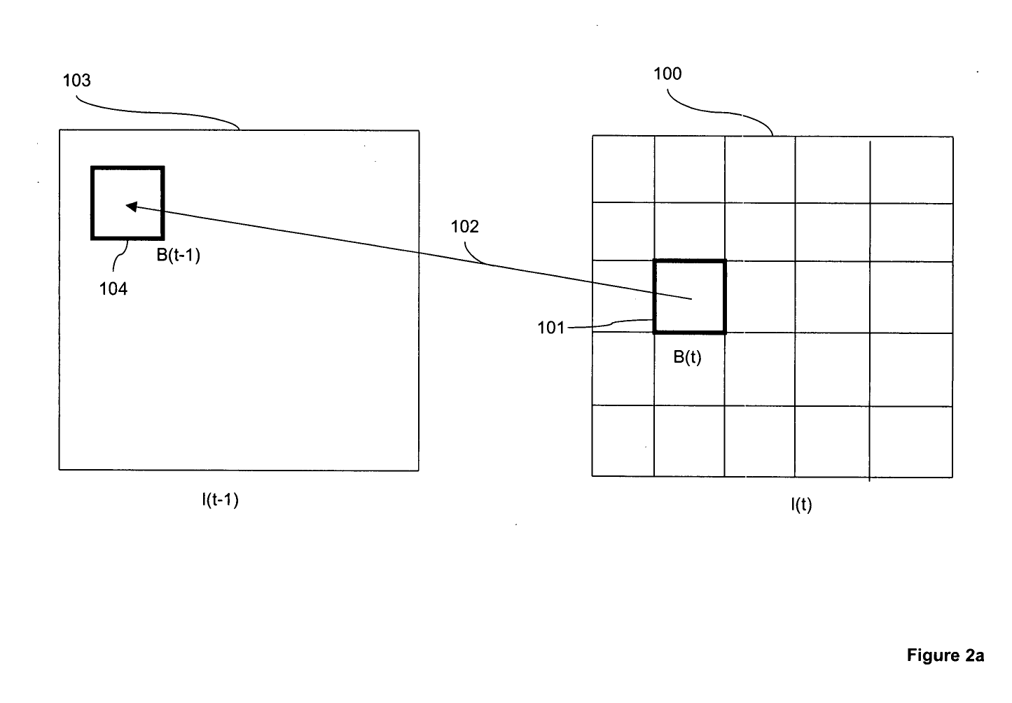

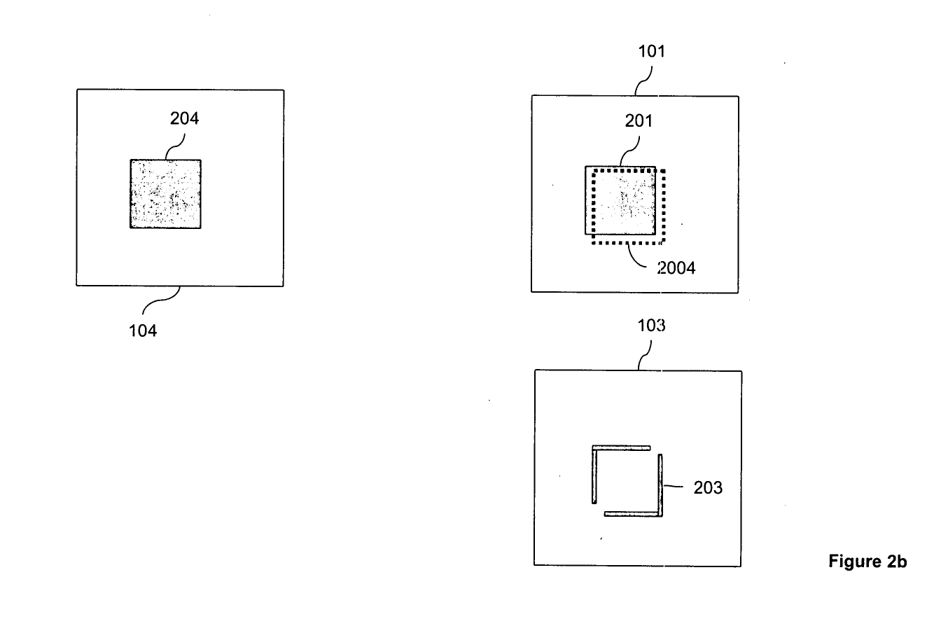

The invention may be applied to MPEG-type compression formats, such as H264, MPEG4 and SVC for example, and is based on the observation that residual data of predicted blocks carry edge information of image areas represented by those blocks. In order to illustrate this concept, FIGS. 2a and 2b show a schematic example.

FIG. 2a represents a schematic view of predictive encoding structure used in MPEG-type compression methods, as briefly described in the introduction.

FIG. 2a illustrates the case of a predicted frame I(t), predicted from a reference frame I(t−1).

Usually, in MPEG-type compression algorithms, the encoding unit is a macroblock, which is a group of blocks. In more general terms, the invention applies to image blocks.

The P-frame called I(t) and denoted 100 in the figure, is divided into blocks, and each block is encoded by prediction from a previous reference frame I(t−1) denoted 103 in the figure. For example, for block 101, the motion vector 102 is calculated during the motion estimation step. The vector 102 points to an area 104 of the reference image I(t−1). At the encoding stage, in the prediction step, the pixel by pixel difference between the data of blocks 101 and 104 is calculated and forms the residual data. Next, the residual data is DCT transformed and quantized.

FIG. 2b represents an example of simple blocks 101 and 104, which are magnified in the figure. The purpose of FIG. 2b is to better illustrate the fact that within an encoding scheme of MPEG-type, residual data carries edge information. Let us assume that the block to be predicted is block 101, which contains a gray square 201 on a white background area. According to the motion estimation, the block 101 is predicted from area 104 of the reference image, which also contains a gray square 204 on a white background. However, the position of the gray square 204, when projected via the motion vector 102 on the block 101, is slightly displaced, as illustrated by the dotted square 2004.

In practice, such an error can occur in particular because the underlying model of motion estimation and compensation as applied in video encoding is translational, but in reality, the motion in real videos may be more complex, including also slight rotations, therefore some estimation errors occur. In other practical cases, the error may occur because of the discretisation of the motion estimation to the pixel.

The prediction error is illustrated by block 103, in which the gray area 203 is the area where some prediction error has occurred. The area 203 is located at the edges of the square 201, where blocks 201 and the projection of block 204 do not coincide. The signal of block 103 is the residual data signal to be encoded in the bitstream according to the encoding format.

This schematic example illustrates the fact that the residual data carries edge information. The chosen example is simple and schematic, but it was verified by practical experiments on examples of video data that the residual data carries edge information.

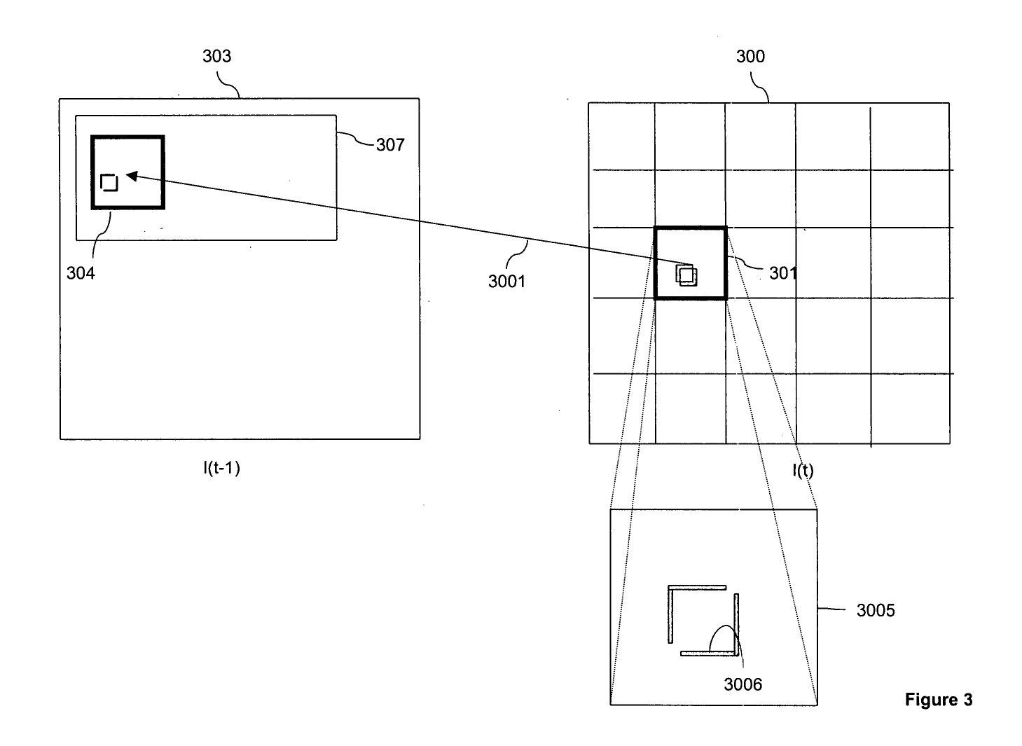

FIG. 3 further illustrates schematically the propagation of low quality reconstruction in a predictive coding scheme, at the decoder side. The image I(t−1) 303 has suffered from some loss during transmission, for example affecting area 307. In this example we consider that the image I(t−1) is an INTRA-type frame with a low correlation with the image I(t−2), and therefore the lost area 307 must be reconstructed by spatial interpolation. The image I(t−1) 303 has been used, at the encoder, as a reference image in the prediction of the following frame I(t) 300. In this example, it is supposed that the predicted image I(t) 300 was received without any error at the decoder.

Since I(t) is a P-frame, its blocks are encoded by prediction from areas of a reference image, which is the previous image I(t−1) in this example.

In particular, block 301 was predicted from an area 304 comprised within the lost area 307 of the image I(t−1). As explained earlier, the residual data corresponding to the difference between the content of block 301 and the content of block 304, transformed by DCT and quantized, is received by the decoder. In the figure, the block 301 is represented after inverse quantization and inverse transformation. Similarly to the example given with respect to FIG. 2b, we consider a block which initially represented a gray square on a white background. As explained above with respect to the FIG. 2b, the residual data encodes a prediction error representative of the edges of the gray square, represented in a magnified version as areas 3006 of block 3005.

Along with the residual data corresponding to the block 301, an associated motion vector 3001, pointing to area 304 of image I(t−1), is also received.

Considering that data relative to area 307 has been lost or corrupted, an error concealment algorithm is applied by the decoder to reconstruct the pixel values for area 307. As explained in the introduction, classical spatial interpolation methods which are fast enough to answer to the constraints of a video decoder (real time or very short delay) introduce some blurring. Therefore, the use of the classical spatial interpolation to reconstruct area 307 results in a relatively bad image quality, which may be considered as being insufficient. However, since at the encoding side, image I(t−1) was used as a reference image to predict image I(t), the reconstructed data from I(t−1) is used to decode image I(t) in classical decoding.

In particular, block 304 would be used to reconstruct block 301 of image I(t), by simply adding the residual data corresponding to block 301 to the reconstructed block 304. It appears therefore clearly that the poor quality of reconstruction is further propagated to block 301. There is a high risk that the poor reconstruction quality is propagated to the following images, in particular to the next image predicted from image I(t), and in particular to any block which is predicted from block 301.

An embodiment of the invention can enhance the image quality of some determined areas of a current image by replacing the classical decoding with an error concealment method using the residual data available for such areas in the current image.

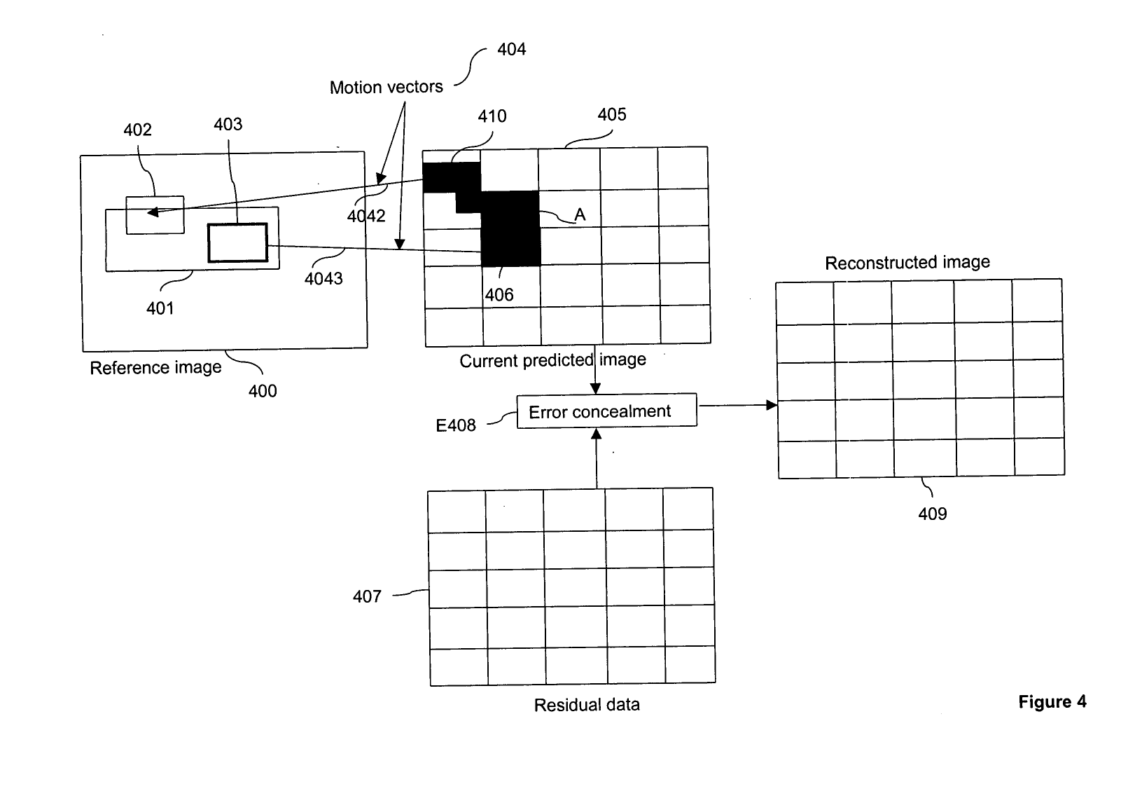

FIG. 4 illustrates the general principle of an example of embodiment of the invention.

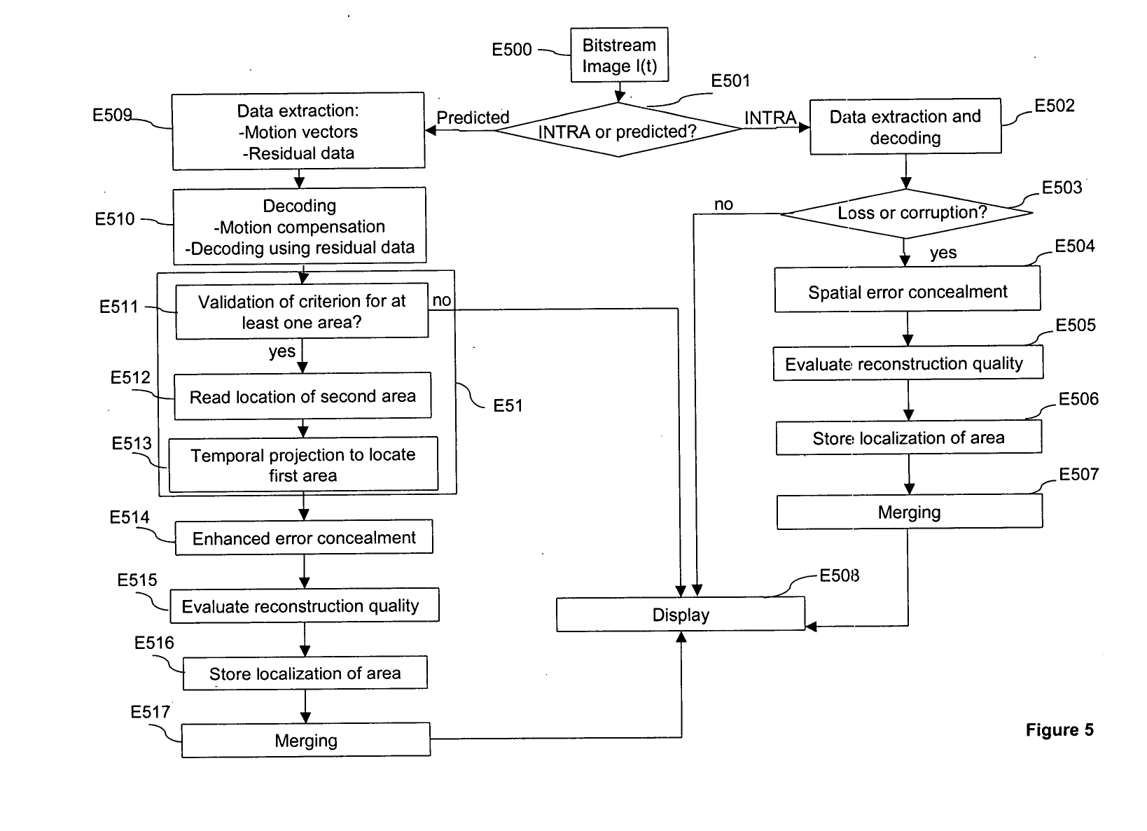

In the embodiment of FIG. 4, data corresponding to images 400 and 405 is received at the decoder. At the encoder side, image 400 was used as a reference to image 405. It is assumed in this example that an area of image 400, referenced as area 401 on the figure, has suffered some loss and was reconstructed using an error concealment algorithm. It is assumed in this example that the error concealment algorithm provides a quality of reconstruction which is evaluated as being insufficient. It will be further described, in relation to FIG. 5, what criteria may be used to evaluate whether the quality of reconstruction is sufficient.

For predicted image 405, it is assumed in this example that the data is correctly received. In particular, residual data 407 corresponding to image 405 is received.

Assuming that the reconstruction of some parts of the reference image is considered of poor quality, the classical decoding is modified to increase the reconstruction quality of image 405.

Firstly, the parts of the image 405 which are predicted from areas with poor reconstruction quality of image 400 are located. In the example of FIG. 4, the gray area A is partially predicted from some parts of area 401 of image 400. For example, block 406 has associated motion vector 4043 which leads to block 403, which is completely inside the lost area 401. Some macroblocks are only partially dependent on area 401 of the reference image. For example, macroblock 410 is predicted via the motion vector 4042 from block 402, which is only partially inside area 401 of insufficient reconstruction quality. So, in a particular embodiment, it may be determined that only the gray area, which is part of macroblock 410, should be reconstructed by error concealment using residual data according to the invention. In an alternative embodiment, even if a macroblock is only partially dependent on a block with insufficient reconstruction quality, the error concealment method chosen may be applied to the entire macroblock.

After the determination of the area A, an enhanced error concealment method using the residual data received for image 405 is applied.

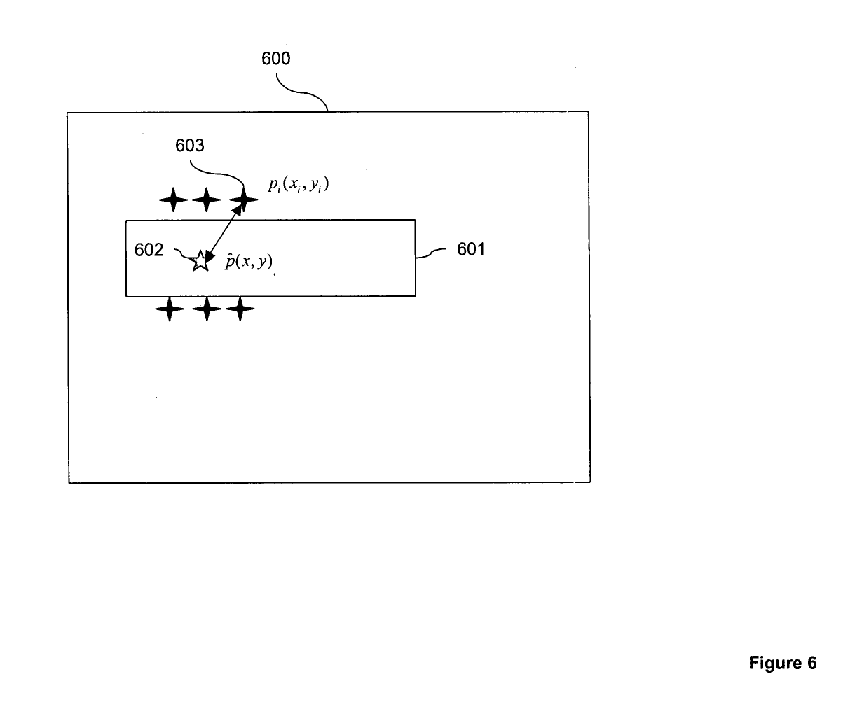

In a particular embodiment, spatial error concealment is applied, using data received for image 405 for parts of the image which are not predicted from areas with poor reconstruction quality, along with the residual data for the area A to be reconstructed, as explained below with respect to FIGS. 6 to 8.

Finally, a reconstructed image 409 is obtained.

In an alternative embodiment, it is envisaged that only part of the data corresponding to the image 405 was correctly received at the decoder. For example, if the encoder uses data partitioning, the motion field is transmitted separately from the residual data. In this case, it may be envisaged that the residual data is correctly received at the decoder, but the motion field, for at least an area of the current image 405, was lost or corrupted and cannot be accurately decoded. In this case, the area to be reconstructed is the area for which the motion field was lost.

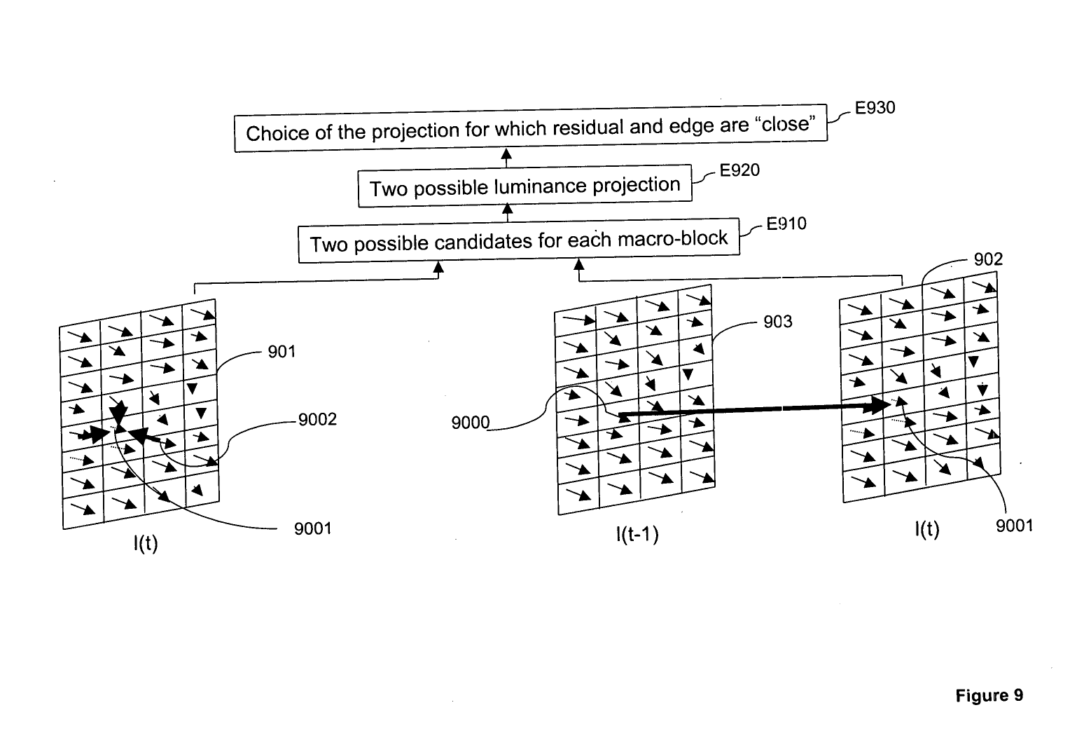

In such a case, a classical temporal error concealment method could be applied. It is possible, in this case also, as explained below with respect to FIG. 9, to enhance the quality of the temporal error concealment by using residual data available for the area to be reconstructed.

A flowchart of an embodiment of the invention is described with respect to FIG. 5. All the steps of the algorithm represented in FIG. 5 can be implemented in software and executed by the central processing unit 1111 of the device 1000.

A bitstream image I(t) is received at step E500.

Next, at step E501, the type of image is tested. If the received image I(t) is of predicted type, either a P-frame or a B-frame, step E501 is followed by step E509 described below.

If the image I(t) is of INTRA type, then step E501 is followed by a step E502 of data extraction and decoding.

Next, at step E503, it is tested if the received image has suffered any loss or corruption.

In case of negative answer to the test E503, the data received for I(t) is complete, and it can be assumed that the full quality of reconstruction has been achieved by decoding, so the image can be displayed next at step E508.

In case of positive answer to the test E503, at least one area of image I(t) has suffered from data loss and cannot be correctly decoded.

Then, a spatial error concealment step is applied at step E504.

At the following step E505 it is evaluated whether the quality of reconstruction of the image signal obtained by error concealment is sufficient or not. In the preferred embodiment, the type of error concealment method used in step E504 is taken into account to evaluate whether the reconstruction quality is sufficient or not.

In the case where a classical fast spatial interpolation was used at step E504, the quality of reconstruction is evaluated as not sufficient, since such a method does not render sufficiently high frequencies, as explained earlier.

If there is some information about the original image available at the decoder, other criteria can be taken into account to evaluate whether the reconstruction quality is sufficient or not.

In case one or several areas with insufficient reconstruction quality have been determined, their localization within image frame I(t) is stored in a storage space of RAM 1112 at step E506.

Finally, the image signal obtained by error concealment is merged with the decoded signal at merging step E507, and the final reconstructed image signal for image I(t) is displayed at display step E508.

If the received image is of predicted type, step E501 is followed by the parsing of the bitstream corresponding to image I(t) at step E509, to extract the data necessary for reconstruction, namely the motion vectors and the residual data.

Next, at step E510 the data is decoded according to the compression format of the bitstream. The motion compensation according to the extracted motion vectors and the decoding using the residual data are applied during this decoding step. After step E510, all areas which do not need further processing are ready for display at step E508 or for further use by the client application.

At step E511, a test is carried out to check whether or not a predetermined criterion for at least one area of the image I(t) is validated. The criterion is validated if an area of the reference image was evaluated as having an insufficient quality of reconstruction.

The location of areas with quality of reconstruction evaluated as not sufficient is stored for each image of the bitstream in a storage space of the RAM 1112, as explained previously with respect to step E506. For a predicted type image, the quality of reconstruction is further evaluated at step E515, as explained below.

If at least one area with insufficient reconstruction quality has been found within the reference image, then the criterion for applying an error concealment instead of classical decoding is validated and step E511 is followed by step E512.

If no one area with insufficient reconstruction quality has been found within the reference image, then the criterion for applying an error concealment instead of classical decoding is not validated, and step E511 is followed by the display step E508.

At next step E512, the location of the area with insufficient reconstruction quality, referred to as second area, is read from the storage space.

The area with insufficient reconstruction quality is then projected at step E513 from the reference image to the predicted image I(t), according to the motion vectors, as explained schematically with respect to FIG. 4. As a result, the temporally corresponding area(s) of image I(t) are located to form at least a first area in image I(t),

The steps E511, E512 and E513 are the sub-steps of a step E51 of determination of at least one first are in image I(t), on which an error concealment method using the available residual data is to be applied.

It is considered in the example of embodiment, without loss of generality, that one such first area is determined at step E513.

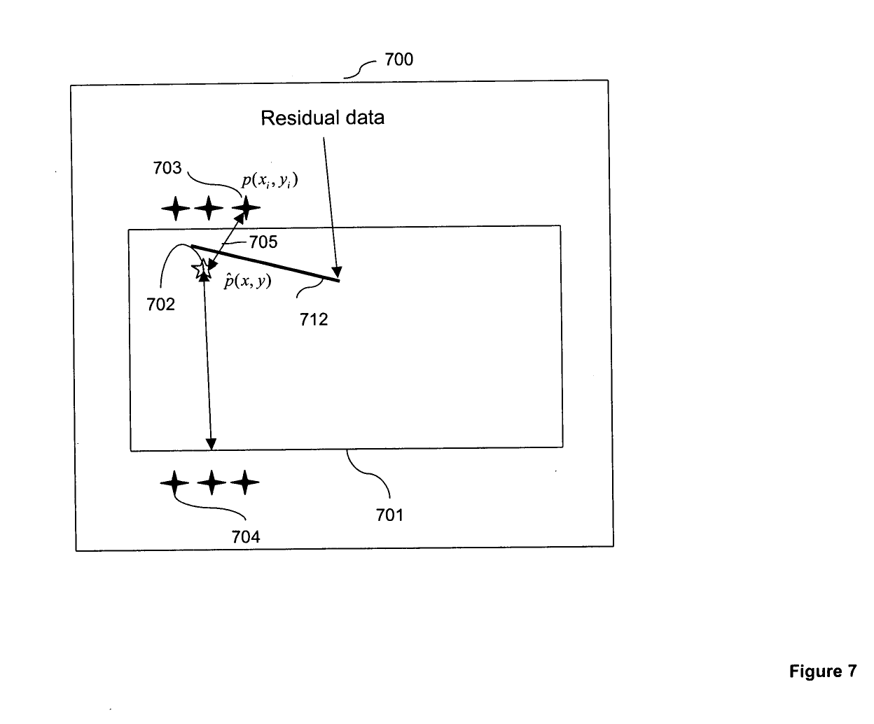

For the blocks of the first area, an enhanced error concealment method using available residual data is applied (step E514). In a preferred embodiment of the invention, a spatial interpolation is applied, using decoded pixel values of pixels in the neighbourhood of the pixels of the first area to be reconstructed and the available residual data, as described with respect to FIGS. 6 and 7.

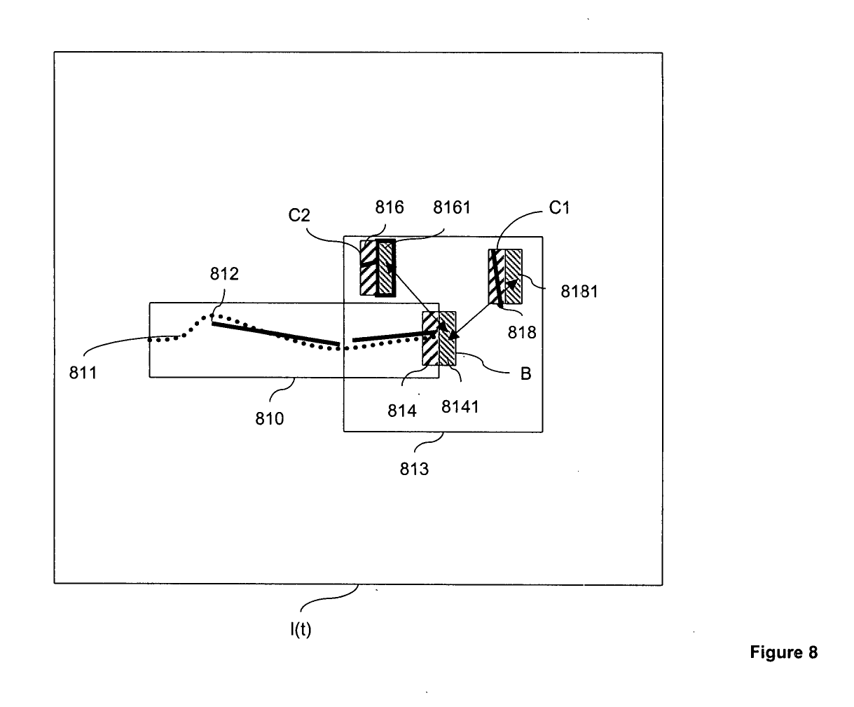

In an alternative embodiment, the spatial error concealment method described with respect to FIG. 8 is applied.

The error concealment step E514 is followed by step E515 wherein the quality of reconstruction is evaluated, since it is possible that the enhanced spatial error concealment is still resulting in insufficient image quality.

As explained further in the examples of spatial error concealment, the residual data is effective to enhance the quality of reconstruction if it carries some edge information. However, in some cases, for a current image to be processed, the quantity of information within the residual data is quite low. In such a case, it can be considered that the enhancement provided by the spatial error concealment applied is not satisfactory.

In practice, the energy of the residual information for an area, which may be either the entire area to be reconstructed, or a block within the area to be reconstructed, may be compared to a predetermined threshold value T. The energy can be calculated by the variance of the residual data signal in the block or by the standard deviation of the residual data signal in the block.

If the energy is lower than the value T, then the quality of reconstruction is evaluated as insufficient. For example, if the energy is calculated as the variance of an area, then a value T=25 can be used when the pixel luminance values are encoded between 0 and 255. This threshold was found empirically to be well adapted to residual data for the test image sequences.

The evaluation of the quality of reconstruction may be applied for each block within the area to be processed, by comparing its energy to the threshold T. If the quality of reconstruction is evaluated as insufficient for the block considered, then its coordinates and size (for example, the coordinates of its upper left corner and its width and height) are stored at step E516 within a storage space of the RAM 1112.

The evaluation of the reconstruction quality E515 and the storage step E516 are repeated for each block within the located first area to be processed, temporally corresponding to second areas of insufficient reconstruction quality in the reference image.

In an alternative embodiment, to evaluate the quality of reconstruction of a block, the continuity of edges between the reconstructed block and other blocks in the neighborhood that are not dependent on insufficient quality data may be checked. In case of detection of a lack of continuity in the edge information, the quality of reconstruction is evaluated as not sufficient.

The pixel values obtained by the enhanced spatial error concealment replace the decoded pixels at the merging step E517. Finally, the fully decoded image is ready for display at step E508. The image obtained after merging is preferably used as a reference for the next predicted image, so as to propagate the enhancement of the quality of reconstruction to the next images.

In an alternative embodiment of the invention, if the energy of a residual data block of the first area is lower than the predetermined threshold T, then it is considered that the enhanced spatial error concealment is insufficient, so that the merging step is not effected for the corresponding block of the current predicted image I(t). Simply, the result of the classical MPEG decoder is conserved for the block considered.

Next, FIGS. 6, 7 and 8 are related to spatial interpolation methods that can be implemented in the enhanced error concealment step E514 of the embodiment of FIG. 5.

FIG. 6 describes schematically a spatial interpolation method. On the figure is represented an image 600, which contains an area to be reconstructed 601. The value of a pixel 602 of the area to be reconstructed 601 can be calculated by a weighted sum of pixels values 603 from the neighborhood of the area 601, according to the following formula:

$$\hat{p} ( x , y ) = {\sum }_{i ∈ V ( x , y )} {w}_{i} {p}_{i} ( {x}_{i} , {y}_{i} ) \qquad ( 1 )$$

where \hat{p}(x, y) represents the estimated value of the signal for pixel 602 situated at coordinates (x, y); pᵢ(xᵢ,yᵢ) represents the image signal decoded or reconstructed value for pixel 603 from a predetermined neighborhood V (x, y), and wᵢ is a weighting factor. The neighborhood can contain, for example, the set of all pixels which are not part of the area to be reconstructed 601, and which are within a predetermined distance D from the pixel 602 considered. For example, V(x,y) contains all pixels which are not in the area 601 and for which the coordinates are within the bounds (xᵢ, yᵢ)ε{(x±D, y±D)}.

The weighting factor is chosen as a function of the distance between the considered pixel 602 and the pixel used for interpolation 603, so as to increase the influence, on the final result, of the pixels that are close and to decrease the influence of the ones that are farther from the considered pixel. Therefore, a formula for the weighting factor may be:

$${w}_{i} = \frac{\frac{1}{{d}_{i} ( x , y )}}{{\sum }_{i ∈ V ( x , y )} \frac{1}{{d}_{i} ( x , y )}} \qquad ( 2 )$$

where dᵢ(x,y) is the distance between pixel 602 at coordinates (x,y) and pixel 603 at coordinates (xᵢ,yᵢ). Classically the quadratic distance is used: dᵢ(x, y)=\sqrt{(x−xᵢ)²+(y−yᵢ)²}, but other types of distances (sum of absolute values of the coordinate difference for example) can also be used.

As explained earlier, this spatial interpolation method has the effect of a low-pass filtering on the signal, and therefore the reconstructed area can appear blurred, in particular if the area to be reconstructed is not completely uniform and contains textures and edges.

The next FIG. 7 illustrates a first embodiment of the use of the residual information to improve the spatial interpolation method described above.

In FIG. 7, an image 700 with an area to be reconstructed 701 and some pixels on the neighbourhood 703, 704 have been represented.

To facilitate the explanation, the residual data decoded was also represented within the area 701 in the form of a contour 712. In this schematic simplified example, it is supposed that the residual data other than the contour 712 is equal to 0, meaning that the image does not possess any other edge in the considered area.

In this embodiment, the residual data is used to modify the weighting factor for each pixel to be used in the interpolation according to formula (1) in the following manner. The modified weighting factor depends on the values of the residual data on a line 705 which joins the pixel to be reconstructed 702 at position (x,y) to the pixel from the neighbourhood 703 at position (xᵢ,yᵢ) as well as the distance dᵢ between pixels 702 and 703.

For example, the following formula to calculate the weighting factor may be used:

$${w}_{i} = \frac{\frac{1}{{d}_{i} ( x , y ) + {r}_{i} ( x , y )}}{{\sum }_{i ∈ V ( x , y )} \frac{1}{{d}_{i} ( x , y ) + {r}_{i} ( x , y )}} \qquad ( 3 )$$

where rᵢ represents a summation of the residual data over a line, represented by line 705 on the figure.

$${r}_{i} = {\sum }_{( p , q ) ∈ Line ( x , y , {x}_{i} , {y}_{i} )} \vert r ( p , q ) \vert \qquad ( 4 )$$

where |r(p,q)| is the absolute value of the residual data for the pixel located at spatial location (p,q).

The weighting factor wᵢ is inversely proportional to the sum of absolute values of residual data of pixels situated on the line joining the pixel to be reconstructed at position (x,y) and the pixel of the neighbourhood at position (xᵢ,yᵢ).

Therefore, the high values of residual data have an effect of virtually increasing the distance between the pixel to be reconstructed and the pixel used for interpolation. It is assumed that if there is a contour in the area to be reconstructed, it is most likely that the textures on the each side of the contour are different, so the contour acts as a barrier to stop a pixel from the other side of the barrier from having a large influence on the final reconstructed values.

In an alternative embodiment, for a pixel to be reconstructed, all the pixels in its neighbourhood are used in equation (1), using weighting factors according to equation (3). At the initialization, all the pixel values of the pixels within the considered area 701 are set to zero. Then, once calculated, the reconstructed values further contribute to reconstruct values in the neighbourhood.

FIG. 8 illustrates another embodiment of the invention, in which the residual data available is used to improve a different spatial error concealment method, based on spatial block matching.

In this example, it is supposed that area 810 of predicted image I(t) is the area that needs to be reconstructed. To achieve the reconstruction, the blocks of the area are successively processed, starting with the blocks close to the border. For example, block 814 is considered. The block-matching method consists in searching, in a predetermined search area 813, for a block that has the highest likelihood to resemble the lost block 814. In order to find such a block, the data that was received and decoded in the rest of the image can be used. A portion 8141 which is adjacent to the block 814 to be reconstructed, but for which the decoded values are available is considered. Blocks 814 and 8141 form a block B. It is then possible to apply block matching to search for the block best matching the block 8141 in terms of image signal content. In a typical embodiment, the distance used for the matching is the mean square difference, and the block minimizing this distance is chosen as a candidate for reconstruction of the lost block.

For example, block 8181 of FIG. 8 is found as being the closest to block 8141, and block 8161 is the second closest one, so there are two candidate blocks. In this case, a classical algorithm would replace block 814 with block 818, assuming by hypothesis that if blocks 8141 and 8181 are similar, it is equally the case for the blocks in their neighborhood. This assumption may however be wrong, since area Cl (composed of block 818 and 8181) may not be related to area B by a simple translation.

In order to illustrate a possible embodiment of the invention, in FIG. 8 is also represented an underlying edge 811 of the area 810, and also residual data 812 decoded for the area 810 according to the invention. Further, residual data containing edge information related to blocks 816 and 818 is also represented.

Using the residual information available it is possible to improve the reconstruction of the block 814, since the residual data can help choosing the block among the two candidate blocks 816 and 818 the one which is closer to block 814 in terms of edge content.

The residual data decoded for the currently processed predicted image I(t) is available for the entire image, and not only for the area 810 containing lost or corrupted data to be reconstructed. In this case, it is possible to calculate a distance between the residual data corresponding to block 814 and respectively to blocks 816 and 818, and to choose, among the two candidate blocks, the one that minimizes such a distance. In practice, the distance between residual data blocks is calculated as the sum of absolute differences between the values of the residual data for each pixel in the block considered. Alternatively, a quadratic distance could be also used. In the example of FIG. 8, block 816 would be chosen, since its residual data is closer to the residual data related to block 814.

Note that in the example of FIG. 8, the predetermined search area 813 is an area of the current image. The search area may be chosen in a previously decoded image. Alternatively, the candidate block for the block matching may be chosen either in the current image or in one or several previously decoded images, so that the search area is distributed among several images.

FIG. 9 illustrates a third embodiment of the invention, in which the residual data is used to enhance the temporal error concealment for a predicted image for which data partitioning was applied, and the residual data was received whereas some motion vectors were lost.

In the example of FIG. 9, the motion vectors of predicted image I(t), represented with a dashed line, are supposed to be lost, for example motion vector 9001.

Two temporal error concealment methods which are motion vector correction methods are envisaged in this embodiment.

A first motion vector correction method is represented on the left hand side of the figure, on representation 901 of image I(t): a lost motion vector 9001 is calculated by combining received motion vectors 9002 from the spatial neighbourhood of the block containing the lost motion vector. This first method achieves a first result, which is a first candidate motion vector pointing at a candidate block for error concealment.

A second motion vector correction method is represented on the right hand side of the figure: the motion vector 9000 from the reference image I(t−1) 903, for the block located at the same coordinates as the current block for which the motion vector is searched for, is simply copied.

Classically, either one or the other method is chosen, based on some prior knowledge.

The two methods lead to two possible candidate blocks for prediction (step E910), which correspond to the two candidate motion vectors. The predicted luminance values for each of these candidate blocks are then calculated at step E920 by luminance projection according to the candidate motion vectors.

Finally, at step E930, the decision of selecting one or the other block is taken using the residual data. In the preferred embodiment, the projected block chosen for prediction is the one for which the edge content is closer to the residual data available. For example, edge detection is carried out for each candidate block, and the result of the edge detection is correlated with the residual data received for the current block.

The choice of a block that best matches the predicted edge content of a current block via the residual data enhances the reconstruction quality.

1. A method for decoding a video sequence encoded according to a predictive format, which video sequence includes predicted images containing encoded residual data representing differences between the respective predicted image and a respective reference image in the video sequence, the method comprising, for a current predicted image of the video sequence:
determining at least one first area of the current predicted image according to meeting of a predetermined criterion;
for at least part of the determined at least one first area, applying an error concealment method, said error concealment method using residual data of the current predicted image relative to said part.

2. The method according to claim 1, further comprising:
evaluating whether the quality of reconstruction of an image signal is sufficient or not, which image signal temporally precedes the current predicted image and is used as a reference for the prediction of the at least one first area;
in case the quality of reconstruction is evaluated as not sufficient, determining that the predetermined criterion has been met.

3. The method according to claim 2, wherein the evaluation of the quality of reconstruction takes into account the type of error concealment method used for reconstruction of said image signal temporally preceding the current predicted image and used as a reference for the prediction of the at least one first area.

4. The method according to claim 3, wherein the quality of reconstruction is always evaluated as not sufficient if the type of error concealment method is spatial error concealment.

5. The method according to claim 2, wherein determining at least one first area further comprises:
reading the location of at least one second area in a reference image of the current predicted image, each second area containing at least part of the image signal temporally preceding the current predicted image and used as a reference for the prediction of the at least one first area;
applying a projection according to motion vectors of said at least one second area on the current predicted image to obtain the location of said at least one first area.

6. The method according to claim 1, further comprising:
evaluating the quality of reconstruction of the image signal obtained by error concealment applied to said at least part of the at least one first area;
in case the quality of reconstruction is evaluated as not sufficient, storing the location of said part of the current predicted image.

7. The method according to claim 6, wherein the quality of reconstruction is evaluated as not sufficient if the energy of the residual data corresponding to said at least part of the at least one first area is lower than a predetermined threshold.

8. The method according to claim 1, wherein the error concealment method is a spatial interpolation method, a value attributed to a pixel to be reconstructed of the at least one first area of the current predicted image being calculated from decoded values of pixels within a spatial neighborhood of said pixel to be reconstructed.

9. The method according to claim 8, wherein the value attributed to a pixel to be reconstructed is calculated by a weighted sum of decoded values for pixels in the neighborhood and wherein each weighting factor depends on the residual data corresponding to said at least one first area.

10. The method according to claim 9, wherein the weighting factor associated with a pixel in the neighborhood is a function of the sum of absolute values of residual data of pixels situated on a line joining said pixel to be reconstructed and said pixel in the neighborhood.

11. The method according to claim 10, wherein said weighting factor is inversely proportional to said sum.

12. The method according to claim 1, wherein the error concealment method selects, to reconstruct said at least part of the at least one first area, at least one of a plurality of candidates and the residual data corresponding to said at least one first area is used to choose between the plurality of candidates.

13. The method according to claim 12, wherein the error concealment method is a spatial block matching method, the residual data corresponding to said at least one first area being used to choose between a plurality of candidate blocks.

14. The method according to claim 12, wherein the error concealment method is a motion vector correction method, the residual data corresponding to said at least one first area being used to choose between a plurality of candidate motion vectors.

15. A device for decoding a video sequence encoded according to a predictive format, which video sequence includes predicted images containing encoded residual data representing differences between the respective predicted image and a respective reference image in the video sequence, the device comprising:
means for determining at least one first area of a current predicted image according to meeting of a predetermined criterion;
means for applying an error concealment method to at least part of the determined at least one first area, said error concealment method using residual data of the current predicted image relative to said part.

16. A non-transitory computer-readable carrier medium storing a program which, when executed by a computer or a processor in a device for decoding a video sequence, causes the device to carry out a method for decoding a video sequence encoded according to a predictive format, which video sequence includes predicted images containing encoded residual data representing differences between the respective predicted image and a respective reference image in the video sequence, the method comprising, for a current predicted image of the video sequence:
determining at least one first area of the current predicted image according to meeting of a predetermined criterion;
for at least part of the determined at least one first area, applying an error concealment method, said error concealment method using residual data of the current predicted image relative to said part.

17. (canceled)

18. A device for decoding a video sequence encoded according to a predictive format, which video sequence includes predicted images containing encoded residual data representing differences between the respective predicted image and a respective reference image in the video sequence, the device comprising:
a determiner that determines at least one first area of a current predicted image according to meeting of a predetermined criterion; and
a processor that applies an error concealment method to at least part of the determined at least one first area, said error concealment method using residual data of the current predicted image relative to said part.
